(19) United States
(12) Patent Application Publication
(10) Pub. No.: US 2018/0046508 A1
(43) Pub. Date: Feb. 15, 2018

(54) APPARATUS ALLOCATING CONTROLLER AND APPARATUS ALLOCATING METHOD

(71) Applicant: H3 Platform, Inc., New Taipei City (TW)

(72) Inventor: Yu-Ching Chou, New Taipei City (TW)

(73) Assignee: H3 Platform, Inc., New Taipei City (TW)

(21) Appl. No.: 15/367,193

(22) Filed: Dec. 2, 2016

(30) Foreign Application Priority Data
Aug. 10, 2016 (TW) 105125445

(51) Int. Cl. G06F 9/50; G06F 13/38; G06F 13/10; G06F 13/42

(52) U.S. Cl. CPC G06F 9/50; G06F 13/4282; G06F 13/385; G06F 13/107; H04L 67/10

(57) ABSTRACT

An apparatus allocating controller is provided in the invention. The apparatus allocating controller includes a bus, a communication interface, and a processor. The bus is coupled to a peripheral apparatus, and the peripheral apparatus meets the peripheral component interconnect express. The communication interface is coupled to a server. The apparatus allocating controller and the peripheral apparatus communicate with the server through the communication interface. The processor is coupled to the bus. The processor is configured to allocate the peripheral apparatus to the server, and monitors the connection status of the peripheral apparatus and the bus. When another peripheral apparatus hot plugs in the bus so that a hot-plug event occurs on the bus, the processor determines whether the another peripheral apparatus has a physical function or a virtual function, and the processor reallocates the peripheral apparatus to the server according to the hot-plug event. An apparatus allocating method is also provided.

### CROSS-REFERENCE TO RELATED APPLICATION

This application claims the priority benefit of Taiwan application serial no. 105125445, filed on Aug. 10, 2016. The entirety of the above-mentioned patent application is hereby incorporated by reference herein and made a part of this specification.

### BACKGROUND OF THE INVENTION

### 1. Field of the Invention

The present invention relates to an apparatus allocating technology, and particularly to an apparatus allocating controller and an apparatus allocating method.

### 2. Description of Related Art

With the development of the cloud computing technologies, the request for the cloud computing and data accessing is getting greater and greater, more companies are need for building the cloud computing center, and the hardware device virtualization technology is provided for the increase of the device utilization rate of the server. The hardware device virtualization technology can be applied on various peripheral apparatus, such as the peripheral apparatus like the network interface controller (NIC) adopting the peripheral component interconnect express (PCIe), RAID HBA, etc. However, a plurality of peripheral apparatuses is used on the same server, and when the hot-plug event occurs on the peripheral apparatus, it usually leads to the calculation failure and the data accessing failure of the server, and further leads to the operating system damage or crashing on the server. In addition, when the resource demand of the plurality of servers is changed, the traditional apparatus allocating method needs to turn off the servers first, then the servers are pulled out from the bus corresponding to the peripheral apparatus or plugged in the bus again manually. These situations all cause the inconvenience on the serve using the peripheral apparatus, and because the server is rebooted constantly, the power consumption is increased simultaneously.

### SUMMARY OF THE INVENTION

The present invention provides an apparatus allocating controller, which is able to support the peripheral apparatus to be hot plugged in the bus and allocated to the server for the usage, and also able to support the peripheral apparatus to be hot plugged out from the bus and reallocate the peripheral apparatus, so as to increase the distribution flexibility of the peripheral apparatus, and the energy consumption is effectively reduced.

The apparatus allocating controller of the invention include a bus, a peripheral apparatus, and a communication interface. The bus is coupled to a plurality of peripheral apparatuses, and the plurality of peripheral apparatuses meets the peripheral component interconnect express. The communication interface is coupled to at least one server. The apparatus allocating controller and the plurality of peripheral apparatuses communicate with the at least one server through the communication interface. The processor is coupled to the bus. The processor is configured to allocate the plurality of peripheral apparatuses to the at least one server, and monitors the connection status of the plurality of peripheral apparatuses and the bus. When another peripheral apparatus hot plugs in the bus so that a hot-plug event occurs on the bus, the processor determines whether the another peripheral apparatus has a physical function or a virtual function, and the processor reallocates the plurality of peripheral apparatuses to the at least one server according to the hot-plug event.

In an embodiment of the invention, the processor cyclically monitors the connection status of the peripheral apparatuses coupled to the bus according to the predetermined time length, so as to determine whether the hot-plug event occurs on the bus.

In an embodiment of the invention, the plurality of peripheral apparatuses and another peripheral apparatus is chosen from at least one of the I/O virtualization apparatus and the non I/O virtualization apparatus, wherein the I/O virtualization apparatus includes the single root I/O virtualization apparatus and the multi-root I/O virtualization apparatus.

In an embodiment of the invention, when another peripheral apparatus is I/O virtualization apparatus, the apparatus allocating controller specifically configures the physical function of the I/O virtualization apparatus to produce the plurality of corresponding virtual functions.

In an embodiment of the invention, when another peripheral apparatus is non I/O virtualization apparatus, the apparatus allocating controller enables the non I/O virtualization apparatus to execute the physical function of the non I/O virtualization apparatus.

In an embodiment of the invention, when one of the plurality of peripheral apparatuses coupled to the bus is hot plugged from the bus, the processor outputs the hot-plug signal to the at least one server. Also, the processor determines whether the at least one server is using the hot-plugged peripheral apparatus through the bus, the determination method includes: when the at least one server is using the hot-plugged peripheral apparatus through the bus currently, the processor outputs the warning signal to the at least one server; when the at least one server is not using the hot-plugged peripheral apparatus through the bus currently, the processor informs the at least one server to uninstall the hot-plugged peripheral apparatus.

The apparatus allocating controller of the invention includes a bus, a communication interface, and a processor. The bus is coupled to a plurality of peripheral apparatuses, and the plurality of peripheral apparatuses meets the peripheral component interconnect express. The communication interface is coupled to at least one server, and the at least one server communicates with the apparatus allocating controller and the plurality of peripheral apparatuses coupled to the bus through the communication interface. The processor is configured to monitor the connection status of the plurality of peripheral apparatuses coupled to the bus. The processor further includes being configured to determine whether the at least one server meets the controlling terminal specification, so as to determine whether the apparatus resource signal is provided to the at least one server according to the connection status of the peripheral apparatus. Also, the processor allocates the plurality of peripheral apparatuses to the at least one server according to the apparatus resource request of the at least one server.

In an embodiment of the invention, the processor builds the apparatus resource pool according to the connection status of the plurality of peripheral apparatuses, and the at least one server determines the apparatus resource request according to the apparatus resource pool.

In an embodiment of the invention, when the apparatus resource request of the at least one server is changed, the processor reallocates the plurality of peripheral apparatuses to the at least one server.

In an embodiment of the invention, when the hot-plug event occurs on the bus, the processor updates the apparatus resource pool, and reallocates the plurality of peripheral apparatuses to the at least one server.

In an embodiment of the invention, the plurality of peripheral apparatuses is chosen from at least one of the I/O virtualization apparatus and the non I/O virtualization apparatus.

The apparatus allocating method of the invention is adapted to the apparatus allocating controller. The apparatus allocating controller is coupled to a plurality of peripheral apparatuses through the bus, and the apparatus allocating controller and the plurality of peripheral apparatuses perform the information communication with the at least one server through the communication interface. The apparatus allocating method includes: allocating the plurality of peripheral apparatuses to the at least one server, and monitoring the connection status of the plurality of peripheral apparatuses and the bus; When another peripheral apparatus hot plugs in the bus so that a hot-plug event occurs on the bus, whether the another peripheral apparatus having a physical function or a virtual function is determined, and reallocating the plurality of peripheral apparatuses and another peripheral apparatus to the at least one server according to the hot-plug event.

In an embodiment of the invention, the step of monitoring the connection status of the plurality of peripheral apparatuses coupled to the bus includes: cyclically monitoring the connection status of the plurality of the peripheral apparatuses coupled to the bus according to the predetermined time length.

In an embodiment of the invention, the step of determining whether another peripheral apparatus having the physical function or the virtual function includes: when another peripheral apparatus is the I/O virtualization apparatus, the physical function of the I/O virtualization apparatus is specifically configured to produce the plurality of corresponding virtual functions.

In an embodiment of the invention, the step of determining whether another peripheral apparatus having the physical function or the virtual function includes: when another peripheral apparatus is the non I/O virtualization apparatus, the non I/O virtualization apparatus is enabled to execute the physical function of the non I/O virtualization apparatus.

In an embodiment of the invention, when the hot-plug event occurs on the bus, the step of updating the apparatus resource signal according to the hot-plug event includes: when one of the plurality of peripheral apparatuses coupled to the bus hot plugs the bus, the hot-plug signal is outputted to the at least one server; and determining whether the at least one server is using the hot-plugged peripheral apparatus through the bus, the determination method includes: when the at least one server is using the hot-plugged peripheral apparatus through the bus currently, the warning signal is outputted to the at least one server; and when the at least one server is not using the hot-plugged peripheral apparatus through the bus currently, the at least one server is informed to uninstall the hot-plugged peripheral apparatus.

The apparatus allocating method of the invention is adapted to the apparatus allocating controller. The apparatus allocating controller is coupled to the plurality of peripheral apparatuses through the bus, and performs the information communication with the at least one server through the communication interface. The apparatus allocating method includes: monitoring the connection status of the plurality of peripheral apparatuses coupled to the bus; determining whether the at least one server meets a predetermined controlling terminal specification, so as to determine whether the apparatus resource signal is provided to the at least one server according to the connection status of the plurality of peripheral apparatuses; and allocating the plurality of peripheral apparatuses to the at least one server according to the apparatus resource request of the at least one server.

In an embodiment of the invention, the step of monitoring the connection status of the plurality of peripheral apparatuses coupled to the bus includes: building the apparatus resource pool according to the connection status of the plurality of peripheral apparatuses, so that the at least one server determines the apparatus resource request according to the apparatus resource pool.

In an embodiment of the invention, the step of allocating the plurality of peripheral apparatuses to the at least one server according to the apparatus resource request of the at least one server includes: when the apparatus resource request of the at least one server is changed, the plurality of peripheral apparatuses is reallocated to the at least one server.

In an embodiment of the invention, the step of allocating the plurality of peripheral apparatuses to the at least one server according to the apparatus resource request of the at least one server includes: when the hot-plug event occurs on the bus, the apparatus resource pool is updated, and the plurality of peripheral apparatuses is reallocated to the at least one server.

Based on the above, the apparatus allocating controller of the embodiment of the invention and the apparatus allocating method are able to monitor the connection status of the peripheral apparatus being coupled to the bus after the server being started, so that the apparatus allocating controller is able to perform the allocation of the peripheral apparatus according to the connection status of the peripheral apparatus after the apparatus allocating controller receives the using request of the server. Also, when the hot-plug event occurs on the server, the apparatus allocating controller can warn the server, furthermore, the server need no rebooting, and the current peripheral apparatus is reallocated to the server directly. In addition, the apparatus allocating controller of the embodiment of the invention and the apparatus allocating method can detect whether the coupled server meets the equipment specifications, so as to warn the user to remove the incompatible server, then the allocation of the peripheral apparatus is performed. By doing so, the embodiment of the invention can effectively increase the flexibility of the server using the peripheral apparatus and avoid the waste of the energy.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of the apparatus allocating controller of an embodiment of the invention.

FIG. 2 illustrates a flow chart of the apparatus allocating method of an embodiment of the invention.

FIG. 3 illustrates a determination flow chart of the hot-plug event occurring in an embodiment of the invention.

FIG. 4 illustrates a determination flow chart of the hot-plug event occurring in another embodiment of the invention.

FIG. 5 illustrates a flow chart of the apparatus allocating method of another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Among the connection relation between the peripheral apparatus and the server in the embodiment of the invention, a peripheral apparatus allocation method and an apparatus allocating controller is provided, so that when the hot-plug event occurs on the server, the server needs no rebooting, and the reallocation of the peripheral apparatus is performed directly. Also, the reallocation of the peripheral apparatus can be performed according to the change of the using demand of the server. By doing so, the saving of the energy can be achieved effectively and the using efficiency of the peripheral apparatus can be increased, and the crashing or damage on the server due to the hot-plug event can be avoided.

Among the full text of the specification of the invention (include the claims), the used term “couple (or connect)” can be referred to as any direct or indirect connection method. For instance, if “first device is connected to second device” is described in the paragraph, then it should be interpreted as “first device can be directly connected to second device”, or “first device can be indirectly connected to second device through other device or some kind of connection method”. Moreover, elements/components/steps with same reference numerals represent same or similar parts in the drawings and embodiments. Same numerals or same terms of the elements/components/steps used in different embodiments can be referred to the cross-reference instruction mutually.

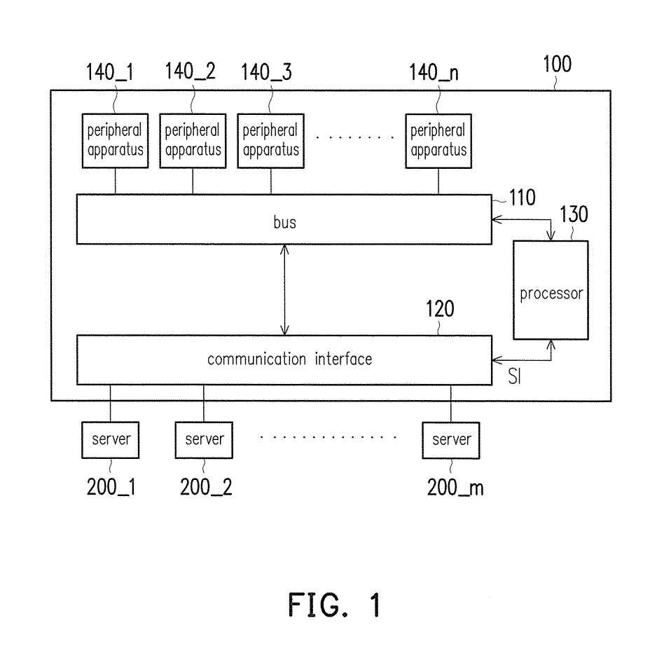

FIG. 1 illustrates a block diagram of the apparatus allocating controller 100 of an embodiment of the invention. Please referring to FIG. 1, the apparatus allocating controller 100 of the invention includes a bus 110, a communication interface 120, and a processor 130. In the embodiment, the bus 110 is coupled to a plurality of peripheral apparatuses 140_{—1}˜140_n, and the peripheral apparatuses 140_1˜140_n all meet the peripheral component interconnect express (PCIe), wherein n is a positive integer equal to or greater than 1. The communication interface 120 is coupled to a plurality of servers 200_1˜200_m, wherein in is an integer equal to or greater than 1. In the embodiment, the processor 130 is configured to monitor each connection status of each of the peripheral apparatuses 140_1˜140_n coupled to the bus 110, and allocate each of the peripheral apparatuses 140_1˜140_n to each of the servers 200_1˜200_m according to the connection status of each of the peripheral apparatuses 140_1˜140_n.

The apparatus allocating controller 100 of the embodiment is an exchange control device of a plurality of virtual machines (VM) configured to be able to dynamically allocate the peripheral apparatuses 140_1˜140_n to the servers 200_1˜200_m or at least one operation system (OS). The apparatus allocating controller 100 can control whether the information between the peripheral apparatuses 140_1˜140_n and the servers 200_1˜200_m is communicated.

In the embodiment, the communication interface 120 may include a plurality of ports for high-speed communication transmission, and these ports meet the PCIe standard. In the embodiment, the communication interface 120 is coupled to the servers 200_1˜200_m respectively through the cable, so as to provide the data transmission function between the peripheral apparatuses 140_1˜140_n and the servers 200_1˜200_m. However, the coupling method between the apparatus allocating controller 100 and the servers 200_1˜200_m can be decided according to the transmission interface adopted by the person applying the present invention, and the mutual communication is performed through the PCIe standard, the invention is not limited thereto. In the embodiment, the servers 200_1˜200_m can communicate with the apparatus allocating controller 100 and the peripheral apparatuses 140_1˜140_n through the communication interface 120 respectively.

Incidentally, the number of the servers able to be coupled to the communication interface 120 can be decided according to the user's demand or the equipment conditions, and the number of the ports is adjusted, the invention is not limited thereto. For example, in an embodiment, the maximum number of the server coupled to the communication interface 120 is 20.

In the embodiment, the processor 130 can be configured to execute the apparatus allocating method of each embodiment of the invention, the processor 130 is central processing unit (CPU), programmable universal or specific micro-central processing unit (MCPU), digital signal processor (DSP), programmable controllers, application specific integrated circuit (ASIC), programmable logic device (PLD) or any other similar device or a combination thereof, for example, so that the apparatus allocating method of the invention is achieved by the software program or the hardware logic circuit.

In the embodiment, the peripheral apparatuses 140_1˜140_n can be chosen from at least one of the I/O virtualization apparatus and non I/O virtualization apparatus, wherein the I/O virtualization apparatus can be single root I/O virtualization apparatus or multi-root I/O virtualization apparatus. That is, in the embodiment, the peripheral apparatuses 140_1˜140_n may include the graphics processing unit (GPU), general-purpose computing on graphics processing unit (GPGPU), non-volatile memory express (NVMe), solid state disk (SSD), network interface controller (NIC), field-programmable gate array (FPGA), redundant array of independent disk (RAID) or any other similar device of combination thereof. For instance, the various peripheral apparatuses may virtualize the apparatus into a plurality of virtual apparatuses having the virtualization technique supporting the single root I/O virtualization technique through a single root I/O virtualization standard, and further includes one or a plurality of PCIe physical function (PF), and each physical function can correspond to at least one virtual function (VF), wherein the virtual function can be used as a virtual machine for the usage and allocation. For instance, a physical function may be divided into 64 virtual functions correspondingly. Or, the peripheral apparatuses 140_1˜140_n may also include a plurality of physical apparatus providing physical functions.

Specifically, in the embodiment, the servers 200_1˜200_m may demand the processor 130 to execute the apparatus allocating operation according to the apparatus resource signal SI respectively, so that the processor allocates the peripheral apparatuses 140_1˜140_n to each of the servers 200_1˜200_m, wherein the apparatus allocating operation is referred to as the processor 130 determining the connection status between the peripheral apparatuses 140_1˜140_n and the servers 200_1˜200_m according to the apparatus using request of each of the servers 200_1˜200_m respectively. More importantly, in the embodiment, when the hot-plug event occurs on the bus 110, the processor 130 may update the apparatus resource signal SI according to the hot-plug event, so that each of the servers 200_1˜200_m can demand the processor 130 to reallocate the usable peripheral apparatuses to servers 200_1˜200_m according to the updated apparatus resource signal SI.

It should be noted that the hot-plug event described in the invention illustrates that after the apparatus allocating controller 100 being turned on, under the condition of not cutting off the power, another peripheral apparatus hot plugs in the bus 110 additionally. Or, after the apparatus allocating controller 100 being turned on, under the condition of not cutting off the power, at least one of the peripheral apparatuses 140_1˜140_n hot plugs out the bus 110. Also, in the embodiment, the processor 130 may configure a time length, monitor the connection status between the bus 110 and the peripheral apparatus using the method of cyclically monitoring, so as to determine whether the hot-plug event occurs on the bus 130.

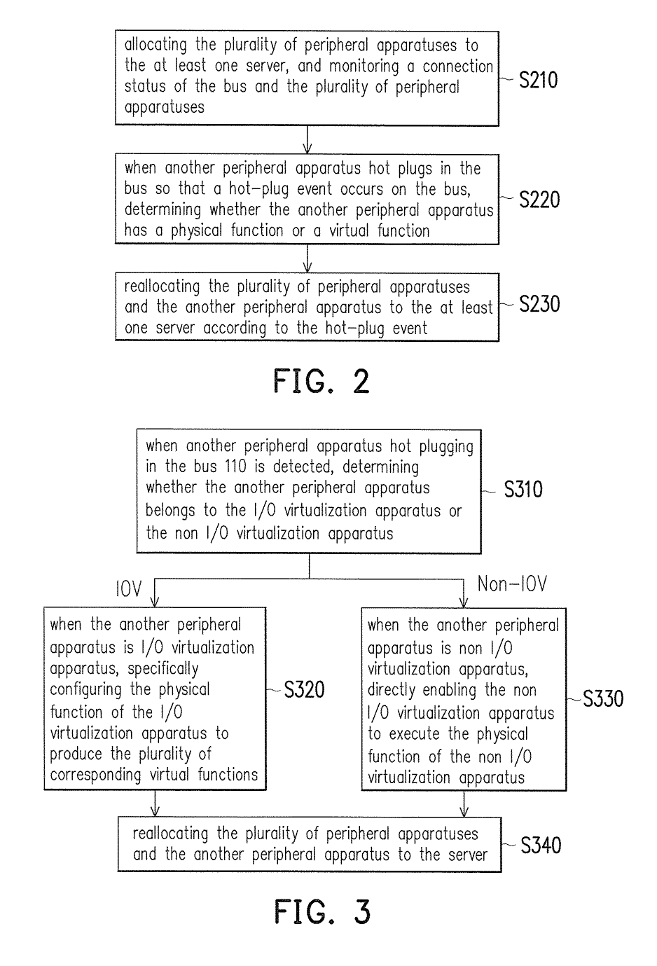

FIG. 2 illustrates a flow chart of the apparatus allocating method of an embodiment of the invention. Please referring to FIG. 1, FIG. 2, the method in the embodiment is at least adapted to the apparatus allocating controller 100 in FIG. 1. In the embodiment, the processor 130 of the apparatus allocating controller 100 is coupled to the plurality of peripheral apparatuses 140_1˜140_n through the bus 110, and performs the information communication with the servers 200_1˜200_m through the communication interface 120. In the step S210, the processor 130 is configured to allocate the peripheral apparatus 140_1˜140_n to the servers 200_1˜200m, and monitors the connection status of the peripheral apparatus 140_1˜140_n and the bus 110. In the step S220, when another peripheral apparatus hot plugs in the bus 110 so that a hot-plug event occurs on the bus 110, the processor 130 determines whether another peripheral apparatus has a physical function or a virtual function. In the step S230, the processor 130 reallocates the peripheral apparatuses 140_1˜140_n and another peripheral apparatus to the servers 200_1˜200_m according to the hot-plug event.

That is, in the embodiment, the processor 130 of the apparatus allocating controller 100 can be configured to allocate the physical function or the virtual function of the peripheral apparatuses 140_1˜140_n for the usage of the servers 200_1˜200m according to the apparatus resource request of the servers 200_1˜200_m. Also, when the hot plugging of another peripheral apparatus into the bus 110 occurs, under the condition of the power of apparatus allocating controller 100 not being cut off, the apparatus allocating controller 100 can reallocate the peripheral apparatuses 140_1˜140_n and another hot plugged peripheral apparatus to the servers 200_1˜200_m.

In addition, in another embodiment, the apparatus allocating controller 100 can be configured to cyclically monitor the connection status of the peripheral apparatus coupled to the bus 110, so as to determine whether the hot-plug event occurs on the bus 110. The apparatus allocating controller 100 can predetermine the cyclically monitoring time length as the time length of 0.1 second, 1 second, or 10 seconds, so that the apparatus allocating controller 100 can repeatedly monitor the bus 110 every 0.1 second, 1 second, or 10 seconds, wherein the cyclically monitoring time length is not limited in the invention. In an embodiment, the cyclically monitoring time length can be determined according to the user's demand or the apparatus condition.

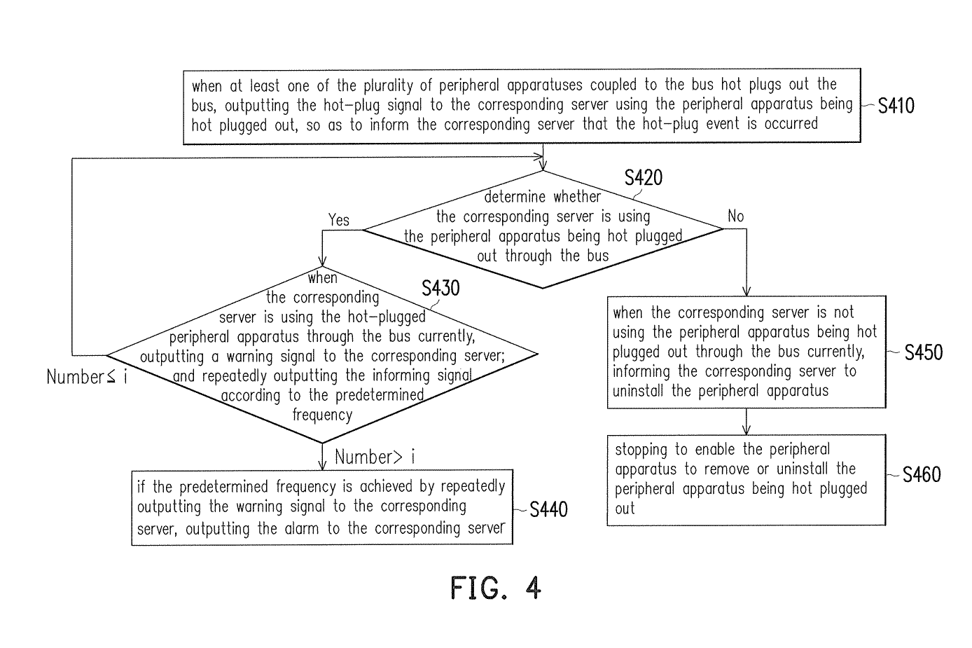

FIG. 3 illustrates a determination flow chart of the hot-plug event occurring in an embodiment of the invention. Please referring to FIG. 1 and FIG. 3, the method in the embodiment is at least adapted to the apparatus allocating controller 100 in FIG. 1. In the embodiment, after the apparatus allocating controller 100 being turned on, and under the condition of the power of the apparatus allocating controller 100 not being cut off, if another peripheral apparatus hot plugs in the bus 110 additionally, the apparatus allocating controller 100 executes the determination flow chart illustrated in FIG. 3.

In the step S310, when the processor 130 detects that another peripheral apparatus hot plug in the bus 110, the processor 130 determines whether another peripheral apparatus belongs to the I/O virtualization apparatus or the non I/O virtualization apparatus. In the step S320, when another peripheral apparatus is I/O virtualization apparatus, the processor 130 specifically configures the physical function of the I/O virtualization apparatus to produce the plurality of corresponding virtual functions. In the step S330, when another peripheral apparatus is non I/O virtualization apparatus, the processor 130 directly enable the non I/O virtualization apparatus, so as to execute the physical function of the non I/O virtualization apparatus, and make the servers 200_1˜200_m able to directly use the physical function of the non I/O virtualization apparatus hot plugged in bus 110. After the execution of the step S320 or S330 is completed, in step S340, the processor 130 can reallocate the peripheral apparatuses 140_1˜140_n and another peripheral apparatus to the servers 200_1˜200_m.

That is, in the embodiment, the apparatus allocating controller 100 can determine whether another peripheral apparatus hot plugged in the bus 110 belongs to the I/O virtualization apparatus or the non I/O virtualization apparatus, so as to perform the corresponding operation steps, so that the apparatus allocating controller 100 directly allocates the physical function or the virtual function of the peripheral apparatus hot plugged in the bus 110 to one of the servers 200_1˜200_m for the usage thereof under the condition of not cutting off the power.

FIG. 4 illustrates a determination flow chart of the hot-plug event occurring in another embodiment of the invention. Please referring to FIG. 1 and FIG. 4, the method in the embodiment is at least adapted to the apparatus allocating controller 100 in FIG. 1. In the embodiment, after the apparatus allocating controller 100 being turned on, under the condition of not cutting off the power, at least one of the peripheral apparatuses 140_1˜140_n hot plugs out the bus 110, then the apparatus allocating controller 100 executes the determination flow chart illustrated in FIG. 4.

In step S410, when at least one of the peripheral apparatuses 140_1˜140_n coupled to the bus 110 hot plugs out the bus 110, the processor 130 outputs the hot-plug signal to the corresponding server using the peripheral apparatus being hot plugged out, so as to inform the corresponding server that the hot-plug event is occurred. In the step S420, the processor 130 determines whether the corresponding server is using the peripheral apparatus being hot plugged out through the bus. In the step S430, when the corresponding server is currently using the peripheral apparatus being hot plugged out through the bus, the warning signal is outputted to the corresponding server, and the informing signal is repeatedly outputted to the corresponding server according to a predetermined number, so that the operation software of the corresponding server can stop the data transmission operation with the peripheral apparatus being hot plugged out according to the informing signal, and the step S420 is performed again for redetermination. In the embodiment, the predetermined number can be configured according to the user's demand or the apparatus condition, the invention is not limited thereto. In the step S440, if the processor 130 repeatedly outputting the warning signal to the server to achieve to predetermined number, the processor 130 outputs the alarm to the server 200, so that the user is informed to manually uninstall or stop the server from using the peripheral apparatus, or the server is forced to remove the function of the peripheral apparatus. In the step S450, when the server is not using the peripheral apparatus being hot plugged out through the bus currently, the processor informs the server to uninstall the peripheral apparatus. In the step S460, the apparatus allocating controller stops enabling the peripheral apparatus to remove or uninstalls the peripheral apparatus being hot plugged out.

In the embodiment, when the processor 130 detects that at least one of the peripheral apparatuses 140_1˜140_n hot plugs out the bus 110, if at least one of the servers 200_1˜200_m still uses the peripheral apparatus being hot plugged out through the bus, the processor 130 transmits the alarm of predetermined number to the corresponding server using the peripheral apparatus being hot plugged out, so that the operation system of the corresponding server can stop the data transmission operation with the peripheral apparatus being hot plugged out according to the alarm. That is, in the embodiment, the apparatus allocating controller 100 can hot plug out the peripheral apparatus coupled to the bus 110 under the condition of not cutting of the power, and the data transmission error due to the occurrence of the hot-plug event can be prevent from occurring on the server using the peripheral apparatus being hot plugged out originally.

It should be noted that the description “at least one of the peripheral apparatuses 140_1˜140_n hot plugs out the bus 110” illustrated in the invention can illustrates that at least one of the peripheral apparatuses 140_1˜140_n hot plugs out the bus 110 expectedly or unexpectedly. Or, it illustrates that the apparatus allocating controller 100 allocates at least one of the peripheral apparatuses 140_1˜140_n from one of the servers 200_1˜200_m to another one of the servers 200_1˜200_m. In an embodiment, if at least one of the peripheral apparatuses 140_1˜140_n is informed to be hot plugged out the bus 110 or allocated to other server for their usage in advance, the corresponding server stop the data transmission operation with the peripheral apparatus being hot plugged out in advance. Then, the processor 130 of the apparatus allocating controller 100 completes the uninstalling of the peripheral apparatus according to the flow chart illustrated in FIG. 4.

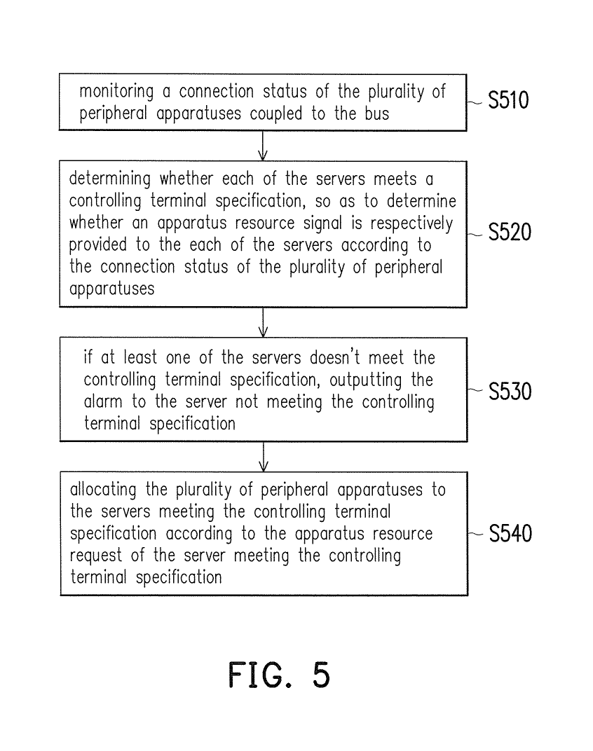

FIG. 5 illustrates a flow chart of the apparatus allocating method of another embodiment of the invention. Please referring to FIG. 1, FIG. 5, the method in the embodiment is at least adapted to the apparatus allocating controller 100 in FIG. 1. In the embodiment, the processor 130 of the apparatus allocating controller 100 is coupled to the plurality of peripheral apparatuses 140_1˜140_n through the bus 110, and performs the information communication with the servers 200_1˜200_m through the communication interface 120. In the step S510, the processor 130 monitors the connection status of the peripheral apparatuses 140_1˜140_n coupled to the bus 110.

In the step S520, the processor 130 determines whether each of the servers 200_1˜200_m meets the controlling terminal specification, so that whether the apparatus resource signal is provided to each of the servers 200_1˜200_m respectively according to the connection status of the peripheral apparatuses 140_1˜140_n is determined. In the step S530, if at least one of the servers 200_1˜200_m doesn't meet the controlling terminal specification, the processor 130 outputs the alarm to the server not meeting the controlling terminal specification, so as to inform the user to stop using or remove the server not meeting the controlling terminal specification. In the step S540, the processor 130 allocates the peripheral apparatuses 140_1˜140_n to the servers meeting the controlling terminal specification according to the apparatus resource request of the server meeting the controlling terminal specification.

In the embodiment, the processor 130 can determine whether the servers 200_1˜200_m is compatible with the apparatus allocating controller 100 and the peripheral apparatuses 140_1˜140_n respectively. Among them, the predetermined controlling terminal specification can illustrate that only under the condition of the server in need of having specific software specification (such as the firmware specification of the 64-bit BIOS or the operation system of the Linux OS), then the apparatus allocating controller 100 allocates the peripheral apparatuses 140_1˜140_n to the server according to the apparatus resource request of the server. Otherwise, the apparatus allocating controller 100 outputs the alarm to the server not meeting the controlling terminal specification, so as to remind the user. However, in the embodiment, the predetermined controlling terminal specification can be designed according to the user's demand or the apparatus condition, the invention is not limited thereto.

In addition, the teachings, suggestions, and embodiments of the apparatus allocating controller and the related apparatus features of the server and the apparatus allocating method of the invention can be fully illustrated by the above descriptions related to each of the embodiments of FIG. 1 to FIG. 3, and are not repeated herein.

Referring to FIG. 1 again, in an embodiment, the processor 130 can build the apparatus resource pool according to the connection status between the peripheral apparatuses 140_1˜140_n and the bus 110. The processor 130 configures the apparatus resource pool as the apparatus resource signal SI, and provides the apparatus resource signal SI to the servers 200_1˜200_m respectively, so that the servers 200_1˜200_m can determine the apparatus resource request required by themselves according to the apparatus resource pool. In addition, when the hot-plug event occurs on the bus 110, the processor 130 updates the apparatus resource pool, and reallocate the current peripheral apparatuses to the servers 200_1˜200_m. In addition, when the apparatus resource request of at least one of the servers 200_1˜200_m is changed, the processor 130 also reallocates the peripheral apparatuses 140_1˜140_n to the servers 200_1˜200_m.

Based on the above, the apparatus allocating controller of the embodiment can monitor the connection status of the peripheral apparatus being coupled to the bus after the server being turned on, and the apparatus resource pool is built. Also, when the hot-plug event occurs on the server, the apparatus allocating controller can update the apparatus resource pool, and inform the server, so that the reallocation of the peripheral apparatuses is performed directly, and the server needs no rebooting. That is, the apparatus allocating controller of the invention can directly configure the peripheral apparatus being hot plugged in specifically. And about the peripheral apparatus being hot plugged out, the server using the peripheral apparatus being hot plugged out is informed to perform the uninstalling or the removing of the peripheral apparatus, and it does no need to reboot the server. In addition, the apparatus allocating controller of the embodiment of the invention can further detect whether the coupled server meets the equipment specifications, so as to warn the user to remove the incompatible server, then the allocation of the peripheral apparatus is performed.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. An apparatus allocating controller, comprising:
a bus, coupled to a plurality of peripheral apparatuses, and the plurality of peripheral apparatuses meets a peripheral component interconnect express;
a communication interface, coupled to at least one server, and the apparatus allocating controller and the peripheral apparatuses communicate with the at least one server through the communication interface; and
a processor, coupled to the bus, configured to allocate the peripheral apparatuses to the at least one server, and monitors the connection status of the bus and the peripheral apparatuses,
wherein when another peripheral apparatus hot plugs in the bus so that a hot-plug event occurs on the bus, the processor determines whether the another peripheral apparatus has a physical function or a virtual function, and the processor reallocates the peripheral apparatuses to the at least one server according to the hot-plug event.

2. The apparatus allocating controller according to claim 1, wherein the processor cyclically monitors the connection status of the peripheral apparatuses coupled to the bus according to a predetermined time length, so as to determine whether the hot-plug event occurs on the bus.

3. The apparatus allocating controller according to claim 1, wherein the peripheral apparatuses and the another peripheral apparatus is chosen from at least one of an I/O virtualization apparatus and a non I/O virtualization apparatus, wherein the I/O virtualization apparatus comprises a single root I/O virtualization apparatus and a multi-root I/O virtualization apparatus.

4. The apparatus allocating controller according to claim 3, wherein when the another peripheral apparatus is I/O virtualization apparatus, the apparatus allocating controller specifically configures the physical function of the I/O virtualization apparatus to produce the plurality of corresponding virtual functions.

5. The apparatus allocating controller according to claim 3, wherein when the another peripheral apparatus is the non I/O virtualization apparatus, the apparatus allocating controller enables the non I/O virtualization apparatus to execute the physical function of the non I/O virtualization apparatus.

6. The apparatus allocating controller according to claim 1, wherein when one of the peripheral apparatuses coupled to the bus is hot plugged from the bus, the processor outputs a hot-plug signal to the at least one server, and determines whether the at least one server is using a hot-plugged peripheral apparatus through the bus, a determination method thereof comprises:
when the at least one server is using the hot-plugged peripheral apparatus through the bus currently, the processor outputs a warning signal to the at least one server; and
when the at least one server is not using the hot-plugged peripheral apparatus through the bus currently, the processor informs the at least one server to uninstall the hot-plugged peripheral apparatus.

7. An apparatus allocating controller, comprising:
a bus, coupled to a plurality of peripheral apparatuses, and the plurality of peripheral apparatuses meets a peripheral component interconnect express;
a communication interface, coupled to at least one server, and the at least one server communicates with the apparatus allocating controller and the plurality of peripheral apparatuses through the communication interface; and
a processor, configured to monitor a connection status of the plurality of peripheral apparatuses coupled to the bus,
wherein the processor further comprises being configured to determine whether the at least one server meets a predetermined controlling terminal specification, so as to determine whether an apparatus resource signal is provided to the at least one server according to the connection status of the plurality of peripheral apparatuses, and allocating the plurality of peripheral apparatuses to the at least one server according to an apparatus resource request of the at least one server.

8. The apparatus allocating controller according to claim 7, wherein the processor builds an apparatus resource pool according to the connection status of the plurality of peripheral apparatuses, and the at least one server determines the apparatus resource request according to the apparatus resource pool.

9. The apparatus allocating controller according to claim 8, wherein when the apparatus resource request of the at least one server is changed, the processor reallocates the plurality of peripheral apparatuses to the at least one server.

10. The apparatus allocating controller according to claim 8, wherein when a hot-plug event occurs on the bus, the processor updates the apparatus resource pool, and reallocates the plurality of peripheral apparatuses to the at least one server.

11. The apparatus allocating controller according to claim 7, wherein the peripheral apparatuses are chosen from at least one of an I/O virtualization apparatus and a non I/O virtualization apparatus.

12. An apparatus allocating method, adapted to an apparatus allocating controller, the apparatus allocating controller is coupled to a plurality of peripheral apparatuses through a bus, and the apparatus allocating controller and the plurality of peripheral apparatuses perform an information communication with at least one server through a communication interface, wherein the apparatus allocating method comprises:
allocating the peripheral apparatuses to the at least one server, and monitoring a connection status of the bus and the peripheral apparatuses;
when another peripheral apparatus hot plugs in the bus so that a hot-plug event occurs on the bus, determining whether the another peripheral apparatus has a physical function or a virtual function; and
reallocating the peripheral apparatuses and the another peripheral apparatus to the at least one server according to the hot-plug event.

13. The apparatus allocating method according to claim 12, wherein a step of monitoring the connection status of the plurality of peripheral apparatuses coupled to the bus comprises:
cyclically monitoring the connection status of the plurality of peripheral apparatuses coupled to the bus according to a predetermined time length.

14. The apparatus allocating method according to claim 12, wherein a step of determining whether the another peripheral apparatus has the physical function or the virtual function comprises:
when the another peripheral apparatus is I/O virtualization apparatus, specifically configuring the physical function of the I/O virtualization apparatus to produce the plurality of corresponding virtual functions.

15. The apparatus allocating method according to claim 12, wherein a step of determining whether the another peripheral apparatus has the physical function or the virtual function comprises:
when the another peripheral apparatus is non I/O virtualization apparatus, enabling the non I/O virtualization apparatus to execute the physical function of the non I/O virtualization apparatus.

16. The apparatus allocating method according to claim 12, wherein a step of reallocating the peripheral apparatuses and the another peripheral apparatus to the at least one server according to the hot-plug event comprises:
when one of the peripheral apparatuses coupled to the bus hot plugs the bus, outputting a hot-plug signal to the at least one server; and
determining whether the at least one server is using a hot-plugged peripheral apparatus through the bus, a determination method thereof comprises:
when the at least one server is using the hot-plugged peripheral apparatus through the bus currently, outputting a warning signal to the at least one server; and
when the at least one server is not using the hot-plugged peripheral apparatus through the bus currently, informing the at least one server to uninstall the hot-plugged peripheral apparatus.

17. An apparatus allocating method, adapted to an apparatus allocating controller, the apparatus allocating controller is coupled to a plurality of peripheral apparatuses through a bus, and performs an information communication with at least one server through a communication interface, wherein the apparatus allocating method comprises:
monitoring a connection status of the plurality of peripheral apparatuses coupled to the bus;
determining whether the at least one server meets a predetermined controlling terminal specification, so as to determine whether an apparatus resource signal is provided to the at least one server according to the connection status of the peripheral apparatuses; and
allocating the plurality of peripheral apparatuses to the at least one server according to an apparatus resource request of the at least one server.

18. The apparatus allocating method according to claim 17, wherein a step of monitoring the connection status of the plurality of peripheral apparatuses coupled to the bus comprises:
building an apparatus resource pool according to the connection status of the plurality of peripheral apparatuses, so that the at least one server determines the apparatus resource request according to the apparatus resource pool.

19. The apparatus allocating controller according to claim 18, wherein a step of allocating the plurality of peripheral apparatuses to the at least one server according to the apparatus resource request of the at least one server comprises:
when the apparatus resource request of the at least one server is changed, reallocating the plurality of peripheral apparatuses to the at least one server.

20. The apparatus allocating controller according to claim 18, wherein a step of allocating the plurality of peripheral apparatuses to the at least one server according to the apparatus resource request of the at least one server comprises:
when a hot-plug event occurs on the bus, updating the apparatus resource pool, and reallocating the plurality of peripheral apparatuses to the at least one server.
